(19) United States
(12) Patent Application Publication
(10) Pub. No.: US 2025/0034841 A1
(43) Pub. Date: Jan. 30, 2025

(54) REMOTE OPERATION SYSTEM OF WORK MACHINE AND REMOTE OPERATIONMETHOD FOR WORK MACHINE

(71) Applicant: Komatsu Ltd., Tokyo (JP)

(72) Inventor: Masanori Aizawa, Tokyo (JP)

(73) Assignee: Komatsu Ltd., Tokyo (JP)

(21) Appl. No.: 18/716,176

(22) PCT Filed: Jan. 12, 2023
(86) PCT No.: PCT/JP2023/000505

§ 371 Date: Jun. 4, 2024

(30) Foreign Application Priority Data
Jan. 12, 2022 (JP) 2022-003145

(51) Int. Cl. E02F 9/20; E02F 9/26; G05D 1/224; G05D 1/226; G05D 105/05; G05D 107/70; G05D 111/30

(52) U.S. Cl. CPC E02F 9/205; E02F 9/261; G05D 1/2247; G05D 1/226; G05D 2105/05; G05D 2107/70; G05D 2111/30

(57) ABSTRACT

A remote operation system of a work machine includes a first operation device that transmits a first operation command to the work machine via a first communication system, a second operation device that generates an operation signal for remotely operating the work machine, and a remote controller that generates a second operation command based on the operation signal to output the second operation command to the first operation device via the second communication system.

### FIELD

The present disclosure relates to a remote operation system of a work machine and a remote operation method for a work machine.

### BACKGROUND

In a technical field related to a work machine, a remote operation system of a work machine as disclosed in Patent Literature 1 is known.

### CITATION LIST

### Patent Literature

Patent Literature 1: JP 2021-136462 A

### SUMMARY

### Technical Problem

There is a demand for a technique capable of reducing the cost of a remote operation system of a work machine.

An object of the present disclosure is to suppress cost related to a remote operation system of a work machine.

### Solution to Problem

According to an aspect of the present invention, a remote operation system of a work machine comprises:
a first operation device that transmits a first operation command to the work machine via a first communication system; a second operation device that generates an operation signal for remotely operating the work machine; and a remote controller that generates a second operation command based on the operation signal to output the second operation command to the first operation device via a second communication system.

### Advantageous Effects of Invention

According to the present disclosure, the cost required for the remote operation system of the work machine is suppressed.

### BRIEF DESCRIPTION OF DRAWINGS

FIG. 1 is a diagram schematically illustrating a remote operation system of a work machine according to the first embodiment.

FIG. 2 is a diagram schematically illustrating the work machine according to the first embodiment.

FIG. 3 is a block diagram illustrating the remote operation system according to the first embodiment.

FIG. 4 is a flowchart illustrating a remote operation method according to the first embodiment.

FIG. 5 is a diagram illustrating a display example of a display device according to the first embodiment.

FIG. 6 is a diagram illustrating a display example of an indicator according to the first embodiment.

FIG. 7 is a diagram illustrating a display example of the display device according to the first embodiment.

FIG. 8 is a diagram illustrating a display example of the display device according to the first embodiment.

FIG. 9 is a diagram illustrating a display example of the display device according to the first embodiment.

FIG. 10 is a block diagram illustrating a remote operation system according to the second embodiment.

FIG. 11 is a block diagram illustrating part of a remote operation system according to the third embodiment.

FIG. 12 is a diagram schematically illustrating a conversion table according to the third embodiment.

FIG. 13 is a flowchart illustrating a method of remotely operating a swing body according to the third embodiment.

FIG. 14 is a flowchart illustrating a method of remotely operating working equipment according to the third embodiment.

FIG. 15 is a flowchart illustrating a method of remotely operating a traveling body according to a third embodiment.

FIG. 16 is a block diagram illustrating a computer system according to an embodiment.

### DESCRIPTION OF EMBODIMENTS

Hereinafter, embodiments according to the present disclosure will be described with reference to the drawings, but the present disclosure is not limited to the embodiments. The constituent elements of the respective embodiments described below is allowed to be appropriately combined. In some cases, some components may not be used.

### First Embodiment

The first embodiment will be described.

### <Overview of Remote Operation System>

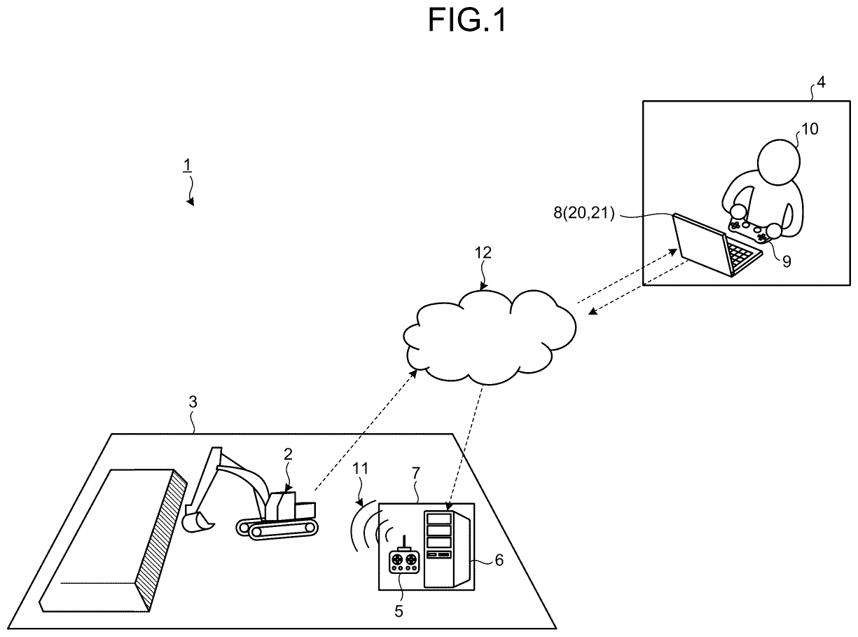

FIG. 1 is a diagram schematically illustrating a remote operation system 1 of a work machine 2 according to the present embodiment.

The remote operation system 1 remotely operates the work machine 2 operating at a work site 3. In the present embodiment, the work machine 2 is assumed to be an excavator.

The remote operation system 1 includes an operation command transmitter 5 (first operation device), a relay controller 6, an information terminal 8, and a remote operation device 9 (second operation device).

Each of the operation command transmitter 5 and the relay controller 6 is disposed at the work site 3 where the work machine 2 operates. A relay chamber 7 is installed at the work site 3. The operation command transmitter 5 and the relay controller 6 are disposed in the relay chamber 7.

Each of the information terminal 8 and the remote operation device 9 is disposed at a location remote from the work site 3. A remote operation room 4 is installed at a location remote from the work site 3. Each of the information terminal 8 and the remote operation device 9 is disposed in the remote operation room 4.

The operation command transmitter 5 transmits a first operation command to the work machine 2 via a first communication system 11. The first operation command is an operation command for operating the work machine 2.

The first communication system 11 transmits the first operation command to the work machine 2 by the first communication method (first communication protocol). The operation command transmitter 5 wirelessly transmits a first operation command to the work machine 2. The first communication system 11 transmits the first operation command by, for example, a radio wave. In the present embodiment, the first communication method is a radio control method. The operation command transmitter 5 is a radio-control transmitter. The work machine 2 is radio-controlled by the operation command transmitter 5. In the present embodiment, the radio-control operation includes, for example, an operation performed from a position where the operator can view the work machine 2. The operation command transmitter 5 is disposed at a position where the operator can view the work machine 2.

The wireless station established for the first communication system 11 is, for example, a wireless station that does not require a license and registration. No radio worker qualification is required when using the first communication system 11. The wireless station established for the first communication system 11 may be a weak wireless station for radio control in which the frequency band of radio waves is a 73 MHz band or the like, may be a specific low power wireless station for a 920 MHz band telemeter and for tele control in which the frequency band of radio waves is a 920 MHz band, or may be a 2.4 GHz band low power data communication system in which the frequency band of radio waves is a 2.4 GHz band.

The relay controller 6 includes a computer system disposed in the relay chamber 7.

The information terminal 8 includes a computer system disposed in the remote operation room 4. A personal computer is exemplified as the information terminal 8. The information terminal 8 includes a remote controller 20 and a display device 21.

The remote operation device 9 generates an operation signal for remotely operating the work machine 2. The operation signal generated by the remote operation device 9 is output to the remote controller 20. The remote controller 20 generates a second operation command based on the operation signal from the remote operation device 9. The remote controller 20 outputs the second operation command to the operation command transmitter 5 via a second communication system 12. In the present embodiment, the remote controller 20 transmits the second operation command to the operation command transmitter 5 via the second communication system 12. The second operation command is an operation command for operating the operation command transmitter 5.

The second communication system 12 transmits the second operation command to the operation command transmitter 5 by a second communication method (second communication protocol) different from the first communication method. The second communication system 12 transmits the second operation command through the electric communication line. A game pad is exemplified as the remote operation device 9. The remote operation device 9 is operated by an operator 10 in the remote operation room 4. In the present embodiment, the remote operation includes, for example, an operation performed from a position where the operator cannot see the work machine 2.

The second communication system 12 may include a public communication line or a specific communication line. The Internet is exemplified as the second communication system 12. Note that the second communication system 12 may include a local area network, a mobile phone communication network, or a satellite communication network. In the present embodiment, the second communication method is an Internet method.

The operation command transmitter 5 transmits a first operation command based on a second operation command from the remote operation device 9. The work machine 2 operates based on the first operation command from the operation command transmitter 5.

### <Work Machine>

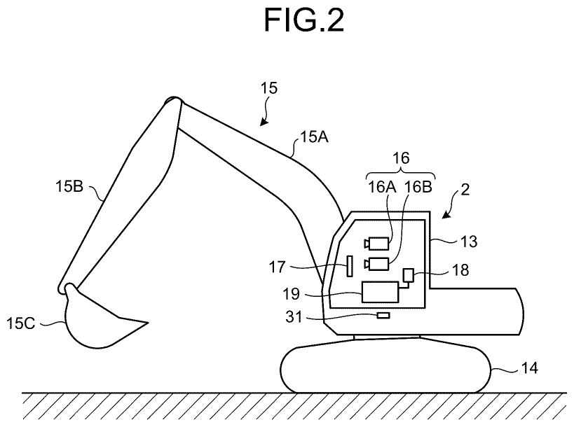

FIG. 2 is a diagram schematically illustrating the work machine 2 according to the present embodiment.

The work machine 2 includes a swing body 13, a traveling body 14, working equipment 15, an imaging device 16, an in-vehicle display device 17, an operation command receiver 18, an in-vehicle controller 19, and an inclination sensor 31.

The swing body 13 swings while being supported by the traveling body 14. The swing body 13 swings about a swing shaft. The traveling body 14 includes a crawler belt.

The working equipment 15 includes a boom 15A, an arm 15B, and a bucket 15C. Each of the boom 15A, the arm 15B, and the bucket 15C operates around a rotation shaft.

In the present embodiment, the vertical direction of the work machine 2 refers to a direction in which the swing shaft of the swing body 13 extends. The left-right direction of the work machine 2 refers to a direction in which the rotation shaft of the working equipment 15 extends. The swing shaft extends in the vertical direction of the swing body 13. The rotation shaft of the working equipment 15 extends in the left-right direction of the swing body 13.

The imaging device 16 is mounted on the work machine 2. The imaging device 16 is disposed, for example, in a driver seat provided in the swing body 13. The imaging device 16 includes a first camera 16A that images a position in front of the swing body 13 and a second camera 16B that images the in-vehicle display device 17. The position in front of the swing body 13 includes the work site 3. The first camera 16A images the work site 3.

Note that both the work site 3 and the in-vehicle display device 17 may be imaged by one camera.

The in-vehicle display device 17 displays a situation around the work machine 2. The work machine 2 includes a surrounding monitoring system. The in-vehicle display device 17 displays a bird's eye image around the work machine 2, for example, a single camera image indicating a position behind the work machine 2, and a reference line indicating the distance from the work machine 2. The single camera image may be an image indicating at least one of a position in front of, left of, and right of the work machine 2. Further, the in-vehicle display device 17 may not display the single camera image while displaying the bird's eye image, or may not display the bird's eye image while displaying the single camera image. Further, the in-vehicle display device 17 may display the vehicle state (water temperature, fuel, an operation mode, a P mode, an E mode, fine operation mode), or may display at least two of the vehicle state, the bird's eye image, and the single camera image in combination.

The operation command receiver 18 receives the first operation command from the operation command transmitter 5. The operation command receiver 18 is a radio-control receiver.

The in-vehicle controller 19 includes a computer system. The in-vehicle controller 19 controls the operation of the work machine 2 based on the first operation command. In addition, the in-vehicle controller 19 transmits the image captured by the imaging device 16 to the remote controller 20. The in-vehicle controller 19 transmits an image of the work site 3 where the work machine 2 operates to the remote controller 20 via the second communication system 12. In-vehicle controller 19 transmits the image of the in-vehicle display device 17 to the remote controller 20 via the second communication system 12. In the present embodiment, the in-vehicle controller 19 transmits an image captured by the imaging device 16 to the remote controller 20 without via the first communication system 11.

The inclination sensor 31 detects an inclination angle of the swing body 13. The inclination sensor 31 includes, for example, an inertial measurement unit (IMU) capable of detecting an inclination angle of the swing body 13. The inclination sensor 31 is disposed at the swing body 13. The inclination sensor 31 detects the pitch angle and the roll angle of the swing body 13 as the inclination angle of the swing body 13. When an axis parallel to the rotation shaft of the working equipment 15 is a pitch axis, the pitch angle refers to an inclination angle centered on the pitch axis. When an axis orthogonal to each of the swing shaft of the swing body 13 and the rotation shaft of the working equipment 15 is a roll axis, the roll angle refers to an inclination angle centered on the roll axis.

### <Remote Operation System>

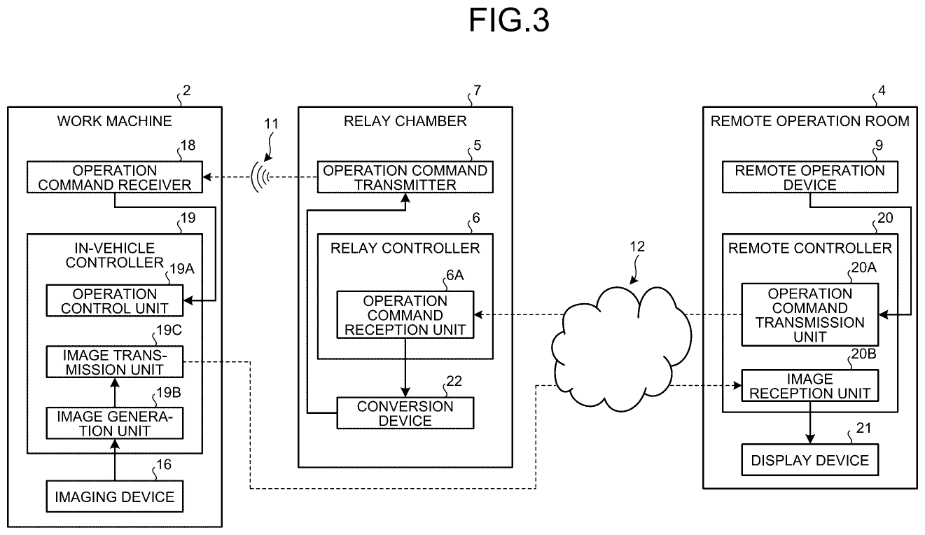

FIG. 3 is a block diagram illustrating the remote operation system 1 according to the present embodiment. The remote operation device 9, the remote controller 20, and the display device 21 are disposed in the remote operation room 4. In the present embodiment, the remote controller 20 and the display device 21 are provided in the information terminal 8. The remote operation device 9 is operated by the operator 10 to generate an operation signal. The remote controller 20 is connected to the remote operation device 9.

The remote controller 20 includes an operation command transmission unit 20A and an image reception unit 20B.

The operation command transmission unit 20A receives an operation signal from the remote operation device 9. The operation command transmission unit 20A generates a second operation command based on the operation signal from the remote operation device 9. The operation command transmission unit 20A transmits the generated second operation command to the relay controller 6 via the second communication system 12.

The image reception unit 20B receives an image captured by the imaging device 16 via the second communication system 12.

The operation command transmitter 5, the relay controller 6, and a conversion device 22 are disposed in the relay chamber 7.

The relay controller 6 includes an operation command reception unit 6A.

The operation command reception unit 6A receives the second operation command transmitted from the remote controller 20 via the second communication system 12.

The conversion device 22 converts the second operation command into the first operation command. The conversion device 22 converts the second operation command of the second communication method into the first operation command of the first communication method. The conversion device 22 includes, for example, a microcomputer and a low-pass filter circuit.

The operation command receiver 18, the in-vehicle controller 19, and the imaging device 16 are disposed in the work machine 2.

The in-vehicle controller 19 includes an operation control unit 19A, an image generation unit 19B, and an image transmission unit 19C.

The operation control unit 19A controls the operation of the work machine 2 based on the first operation command received by the operation command receiver 18. The work machine 2 operates based on the first operation command. The operation of the work machine 2 includes a swinging operation of the swing body 13, a traveling operation of the traveling body 14, and a work operation of the working equipment 15.

The image generation unit 19B generates an image to be transmitted to the remote controller 20 based on imaging data captured by the imaging device 16. The image transmitted to the remote controller 20 includes, for example, an image of the work site 3 captured by the first camera 16A and an image of the in-vehicle display device 17 captured by the second camera 16B. Image transmission unit 19C transmits the image generated by the image generation unit 19B to the remote controller 20 via the second communication system 12. The image generated by the image generation unit 19B is transmitted to the remote operation room 4 not via the first communication system 11 but via the second communication system 12, whereby a decrease in work efficiency due to a video delay is suppressed.

### <Remote Operation Method>

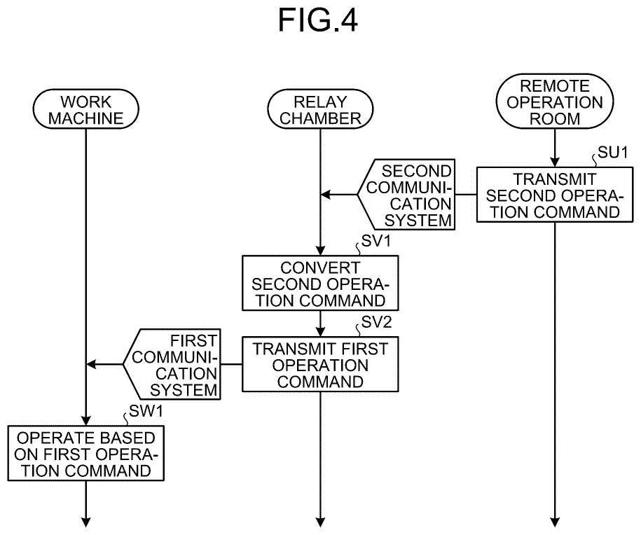

FIG. 4 is a flowchart illustrating a remote operation method according to the present embodiment.

When the operator 10 operates the remote operation device 9, the remote operation device 9 generates an operation signal. The operation command transmission unit 20A of the remote controller 20 generates a second operation command for operating the operation command transmitter 5 based on the operation signal generated by the remote operation device 9. The operation command transmission unit 20A transmits the generated second operation command to the relay controller 6 via the second communication system 12 (step SU1).

The operation command reception unit 6A of the relay controller 6 receives the second operation command transmitted via the second communication system 12. The operation command reception unit 6A outputs the second operation command to the conversion device 22. The conversion device 22 converts the second operation command to generate a first operation command (step SV1).

The conversion device 22 outputs the first operation command generated based on the second operation command to the operation command transmitter 5. The operation command transmitter 5 transmits the first operation command to the work machine 2 via the first communication system 11 (step SV2).

The operation command receiver 18 of the work machine 2 receives the first operation command transmitted via the first communication system 11. The operation command receiver 18 outputs the received first operation command to the operation control unit 19A of the in-vehicle controller 19. The operation control unit 19A controls the operation of the work machine 2 based on the first operation command. The work machine 2 operates based on the first operating command (step SW1).

The first camera 16A outputs imaging data of the work site 3 to the image generation unit 19B. The second camera 16B outputs imaging data of the in-vehicle display device 17 to the image generation unit 19B. The image generation unit 19B generates a predetermined image by combining the imaging data of the work site 3 and the imaged data of the in-vehicle display device 17. Image transmission unit 19C transmits the image generated by the image generation unit 19B to the remote controller 20 via the second communication system 12. Image reception unit 20B of the remote controller 20 receives the image transmitted from the in-vehicle controller 19. The image reception unit 20B outputs the image transmitted from the in-vehicle controller 19 to the display device 21. The display device 21 displays the image transmitted from the in-vehicle controller 19.

The display device 21 displays an image of the work site 3 and an image of the in-vehicle display device 17. The operator 10 in the remote operation room 4 can visually recognize the situation of the work site 3 via the display device 21. The operator 10 in the remote operation room 4 operates the remote operation device 9 while viewing the image displayed on the display device 21. The work machine 2 is remotely operated by the remote operation device 9.

### <Display Device>

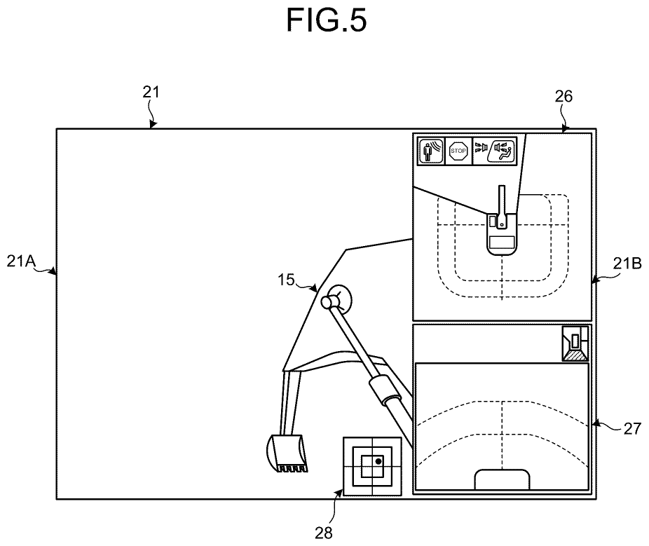

FIG. 5 is a diagram illustrating a display example of the display device 21 according to the present embodiment.

As illustrated in FIG. 5, an image of the work site 3 captured by the first camera 16A is displayed in a first display area 21A of the display device 21. The image of the work site 3 captured by the first camera 16A includes an image in front of the swing body 13. The image in front of the swing body 13 includes an image of the working equipment 15. The image of the in-vehicle display device 17 captured by the second camera 16B is displayed in a second display area 21B of the display device 21. As described above, the in-vehicle display device 17 displays the bird's eye image around the work machine 2 and the single camera image indicating the position behind the work machine 2. In the second display area 21B of the display device 21, a bird's eye image 26 around the work machine 2 displayed on the in-vehicle display device 17 and a single camera image 27 indicating the position behind the work machine 2 are displayed.

In the present embodiment, the display device 21 displays an indicator 28 indicating the inclination angle of the swing body 13. The indicator 28 is displayed based on the detection data of the inclination sensor 31.

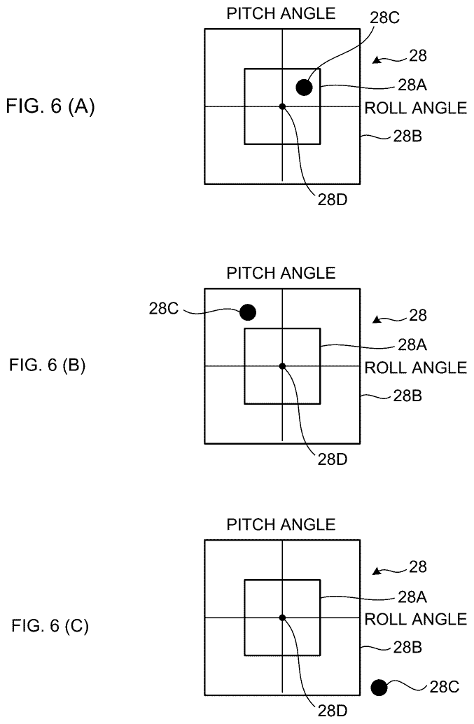

FIG. 6 is a diagram illustrating a display example of the indicator 28 according to the present embodiment.

As illustrated in FIG. 6, the indicator 28 includes a first frame 28A indicating a first threshold value related to each of the pitch angle and the roll angle, a second frame 28B indicating a second threshold value related to each of the pitch angle and the roll angle, and a symbol 28C indicating detection data of the inclination sensor 31. The second threshold value is larger than the first threshold value. Symbol 28C moves the indicator 28 based on the detection data of the inclination sensor 31. When each of the pitch angle and the roll angle is 0 degrees, the symbol 28C is disposed at an origin 28D of the indicator 28. The first frame 28A is displayed so as to surround the origin 28D. The second frame 28B is displayed so as to surround the first frame 28A. As illustrated in FIG. 6(A), when each of the pitch angle and the roll angle falls below the first threshold value, that is, when the symbol 28C is disposed inside the first frame 28A, each of the first frame 28A and the second frame 28B is displayed in a first display state (for example, blue). As illustrated in FIG. 6(B), when at least one of the pitch angle and the roll angle exceeds the first threshold value, that is, when the symbol 28C is disposed outside the first frame 28A, the first frame 28A is displayed in a second display state (for example, yellow). As illustrated in FIG. 6(C), when at least one of the pitch angle and the roll angle exceeds the second threshold value, that is, when the symbol 28C is disposed outside the second frame 28B, the second frame 28B is displayed in a third display state (for example, red).

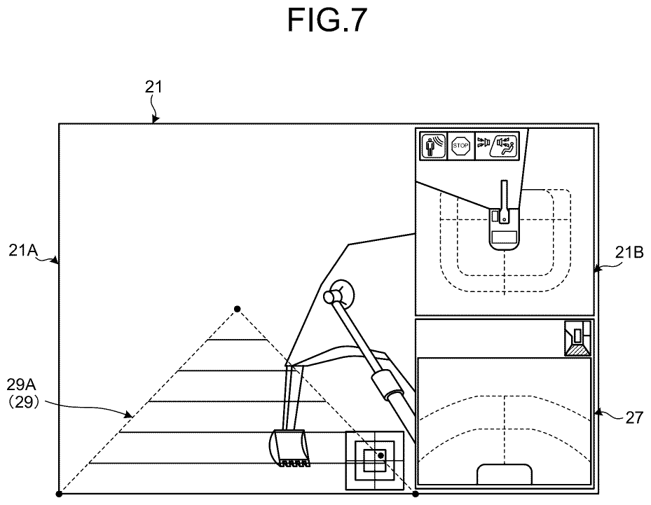

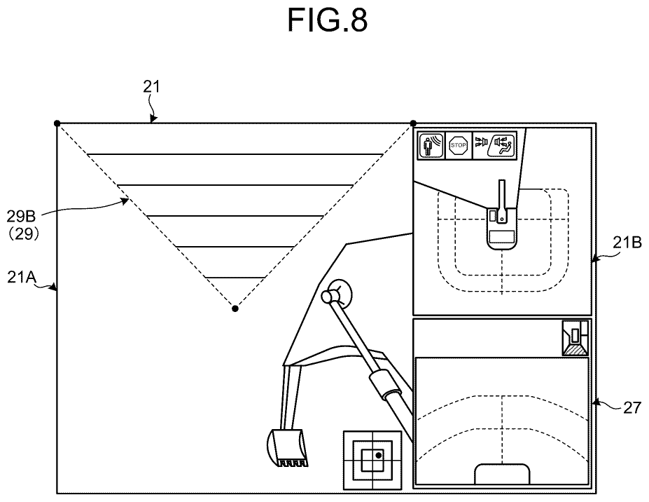

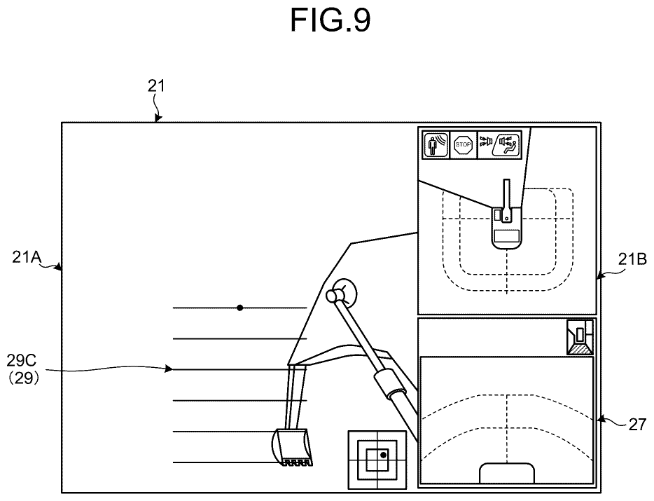

Each of FIGS. 7, 8, and 9 is a diagram illustrating a display example of the display device 21 according to the present embodiment. As illustrated in each of FIGS. 7, 8, and 9, the display device 21 can display a reference line 29 indicating the distance from the work machine 2 in the first display area 21A. The reference line 29 includes a plurality of lines. The plurality of lines is parallel to each other. The widths of the plurality of lines constituting the reference line 29A illustrated in FIG. 7 decrease as the distance from the work machine 2 increases. The widths of the plurality of lines constituting the reference line 29B illustrated in FIG. 8 increase as the distance from the work machine 2 increases. The widths of the plurality of lines constituting the reference line 29C illustrated in FIG. 9 are constant regardless of the distance from the work machine 2. A reference line 29A illustrated in FIG. 7 is displayed at the lower part of the first display area 21A. A reference line 29B illustrated in FIG. 8 is displayed at the upper part of the first display area 21A. A reference line 29C illustrated in FIG. 9 is displayed at the lower part of the first display area 21A. The operator 10 can arbitrarily change the number, width, and position of the lines constituting the reference line 29 by operating the remote operation device 9.

Note that the operator can arbitrarily select and display the display example illustrated in FIG. 7, the display example illustrated in FIG. 8, and the display example illustrated in FIG. 9 on the display device 21. In the display examples illustrated in FIGS. 7, 8, and 9, the reference line 29 may not be displayed.

### <Effects>

As described above, according to the present embodiment, the operation command transmitter 5 that wirelessly operates the work machine 2 via the first communication system 11 is operated by the remote operation device 9 via the second communication system 12. The work machine 2 is remotely operated by the remote operation device 9 via the operation command transmitter 5. In a case where a wireless operation system for wirelessly operating the work machine 2 by the operation command transmitter 5 has already been constructed, or in a situation where the work machine 2 has already been operated by radio-control operation at the work site 3, the remote operation system 1 is constructed only by adding the second communication system and the remote operation device 9 to the wireless operation system. Therefore, the cost required for the remote operation system 1 of the work machine 2 is suppressed. The remote operation system 1 is configured at low cost.

The conversion device 22 that converts the second operation command into the first operation command is provided. Therefore, even when the communication method of the first communication system 11 is different from the communication method of the second communication system 12, the operator 10 can remotely operate the work machine 2 with the remote operation device 9. For example, even when the communication method of the first communication system 11 is the radio control method and the communication method of the second communication system 12 is the Internet method, the first operation conversion of the second operation command by the conversion device 22 allows the operator 10 to remotely operate the work machine 2 with the remote operation device 9.

### <Modifications>

In the present embodiment, the first communication system 11 performs communication in a radio control method. The first communication system 11 may perform communication by a wireless local area network (LAN) method or may perform communication by a wireless personal area network (PAN) method.

In the present embodiment, the operation command transmission unit 20A and the image reception unit 20B may be configured by separate hardware (computer system). In the present embodiment, the conversion device 22 may be configured by the relay controller 6. In the present embodiment, the operation control unit 19A, the image generation unit 19B, and the image transmission unit 19C may be configured by separate hardware (computer system).

### Second Embodiment

The second embodiment will be described. In the following description, the same or equivalent components as those of the above-described embodiment are denoted by the same reference numerals, and the description of the components is simplified or omitted.

### <Remote Operation System>

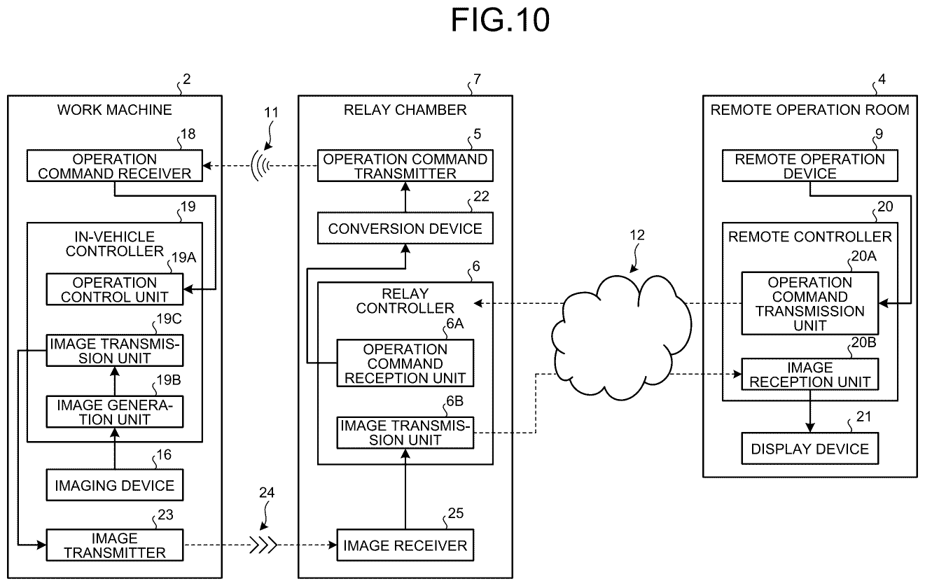

FIG. 10 is a block diagram illustrating the remote operation system 1 according to the present embodiment.

In the present embodiment, the work machine 2 includes an image transmitter 23 that transmits an image of the work site 3 and an image of the in-vehicle display device 17. As in the first embodiment described above, the imaging data of the imaging device 16 is output to the image generation unit 19B. The image generated by the image generation unit 19B is transmitted to the image transmitter 23 via the image transmission unit 19C. The image transmitter 23 transmits an image to an image receiver 25 disposed at the work site 3. The image receiver 25 is disposed in the relay chamber 7.

The image transmitter 23 transmits the image of the work site 3 and the image of the in-vehicle display device 17 to the image receiver 25 via a third communication system 24. The third communication system 24 transmits an image to the image receiver 25 by a third communication method (third communication protocol) different from the first communication method and the second communication method. The third communication system 24 wirelessly transmits an image. A video transmitter is exemplified as the image transmitter 23 and the image receiver 25. The third communication method may be a unique communication method defined in the video transmitter.

The relay controller 6 includes an image transmission unit 6B that transmits the image of the work site 3 and the image of the in-vehicle display device 17 received by the image receiver 25 to the remote controller 20. The image transmission unit 6B transmits the image of the work site 3 and the image of the in-vehicle display device 17 to the remote controller 20 via the second communication system 12.

### <Effects>

As described above, in the present embodiment, the image captured by the imaging device 16 is transmitted from the work machine 2 to the relay controller 6 via the third communication system 24, and then transmitted from the relay controller 6 to the remote controller 20 via the second communication system 12. As a result, even when the work machine 2 performs work at a position where it is difficult to transmit an image at the work site 3, the image captured by the imaging device 16 is smoothly transmitted to the remote controller 20.

At the work site 3, the image transmission speed by the third communication system 24 is higher than the image transmission speed by the second communication system 12. The third communication system 24 can transmit an image with a lower delay than the second communication system 12. Further, at the work site 3, the communication stability of the third communication system 24 is higher than the communication stability of the second communication system 12. In the work site 3, there is a possibility that the work machine 2 performs work at a position where communication is difficult in the second communication system 12. In the work site 3, when the relay chamber 7 is located at a position where communication by the second communication system 12 is easy, an image captured by the imaging device 16 is transmitted from the work machine 2 to the relay controller 6 disposed in the relay chamber 7 via the third communication system 24, whereby the image captured by the imaging device 16 is smoothly transmitted from the relay controller 6 to the remote controller 20 via the second communication system 12.

### <Modifications>

In the present embodiment, the operation command reception unit 6A and the image transmission unit 6B may be configured by separate hardware (computer system).

### Third Embodiment

The third embodiment will be described. In the following description, the same or equivalent components as those of the above-described embodiment are denoted by the same reference numerals, and the description of the components is simplified or omitted.

### <Remote System>

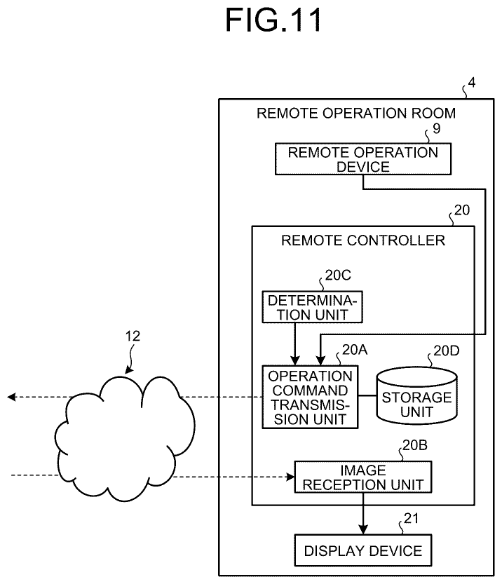

FIG. 11 is a block diagram illustrating part of the remote operation system 1 according to the present embodiment.

The remote controller 20 includes the operation command transmission unit 20A, the image reception unit 20B, a determination unit 20C, and a storage unit 20D.

As in the above-described embodiment, the remote operation device 9 generates an operation signal for remotely operating the work machine 2. The operation command transmission unit 20A transmits a second operation command for remotely operating the work machine 2 based on the operation signal generated by the remote operation device 9.

The determination unit 20C determines whether communication between the work machine 2 and the remote operation device 9 has been established. In addition, the determination unit 20C determines whether a predetermined period has elapsed from the time point at which the communication between the work machine 2 and the remote operation device 9 is established. In the present embodiment, for example, a timer is provided in the remote controller 20. The determination unit 20C determines, based on the timer, whether a predetermined period has elapsed from the time point at which the communication between the work machine 2 and the remote operation device 9 was established.

The operation command transmission unit 20A transmits a second operation command so that a first operation speed (fine operation speed) indicating an operation speed of the work machine 2 when communication between the work machine 2 and the remote operation device 9 is established is slower than a second operation speed (normal speed) indicating a predetermined operation speed associated in advance with an operation amount of the remote operation device 9.

The second operation speed is an operation speed associated in advance with the operation amount of the remote operation device 9, and is a normal speed of the work machine 2 that operates based on the operation amount of the remote operation device 9. The first operation speed is a fine operation speed lower than the second operation speed. In the present embodiment, when the remote operation device 9 is operated with a predetermined operation amount, there are a case where the work machine 2 operates at the first operation speed and a case where the work machine 2 operates at the second operation speed.

The operation control unit 19A (see FIG. 3, FIG. 10, etc.) of the in-vehicle controller 19 controls the work machine 2 based on the second operation command from the operation command transmission unit 20A. As in the above-described embodiment, the operation command transmitter 5 is operated based on the second operation command, and the operation control unit 19A controls the work machine 2 based on the first operation command from the operation command transmitter 5. The operation control unit 19A controls the work machine 2 so that a first operation speed indicating an operation speed of the work machine 2 when communication between the work machine 2 and the remote operation device 9 is established is slower than a second operation speed indicating a predetermined operation speed associated in advance with the operation amount of the remote operation device 9.

In the present embodiment, the operation command transmission unit 20A transmits a second operation command to the operation command transmitter 5 (relay controller 6) so that the work machine 2 operates at the first operation speed in a case where it is determined that the predetermined period has not elapsed from the time point when the communication between the work machine 2 and the remote operation device 9 is established, and the work machine 2 operates at the second operation speed higher than the first operation speed in a case where it is determined that the predetermined period has elapsed from the time point when the communication between the work machine 2 and the remote operation device 9 is established. The predetermined period is a preset period.

In the present embodiment, a conversion table is stored in the storage unit 20D. The operation command transmission unit 20A converts the second operation command based on the determination data of the determination unit 20C and the conversion table stored in the storage unit 20D, and then transmits the converted second operation command. In a case where it is determined that the predetermined period has not elapsed, the operation command transmission unit 20A converts the second operation command so that the work machine 2 operates at the first operation speed, and then transmits the converted second operation command. In a case where it is determined that the predetermined period has elapsed, the operation command transmission unit 20A converts the second operation command so that the work machine 2 operates at the second operation speed higher than the first operation speed, and then transmits the converted second operation command. Before a predetermined period elapses from a time point at which communication between the work machine 2 and the remote operation device 9 is established, the operation control unit 19A controls the work machine 2 so that the work machine 2 operates at the first operation speed. The operation control unit 19A switches the operation speed of the work machine 2 from the first operation speed to the second operation speed after a lapse of a predetermined period from a time point at which communication between the work machine 2 and the remote operation device 9 is established.

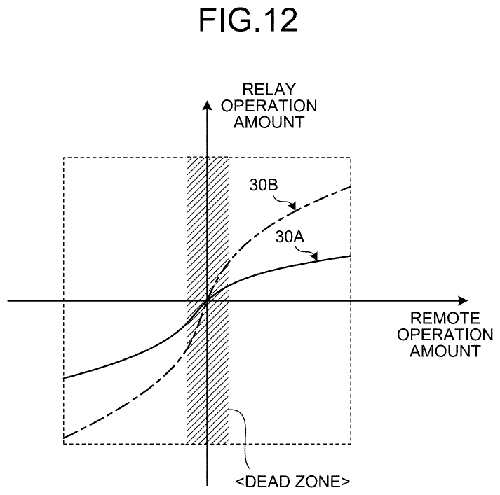

FIG. 12 is a diagram schematically illustrating a conversion table according to the present embodiment.

The conversion table indicates the relationship between the relay operation amount indicating the operation amount related to the first operation command output from the operation command transmitter 5 and the remote operation amount indicating the operation amount related to the second operation command output from the remote operation device 9. The conversion table is a conversion table for converting the remote operation amount into the relay operation amount. The conversion table includes a fine operation table 30A (first conversion table) used in a case where it is determined that the predetermined period has not elapsed and a normal table 30B (second conversion table) used in a case where it is determined that the predetermined period has elapsed. As illustrated in FIG. 12, the ratio between the relay operation amount and the remote operation amount is different between before the predetermined period elapses and after the predetermined period elapses. That is, the gain of the relay operation amount with respect to the remote operation amount is different between the fine operation table 30A and the normal table 30B. The gain of the relay operation amount with respect to the remote operation amount before the predetermined period elapses (in the case of the fine operation table 30A) is smaller than the gain of the relay operation amount with respect to the remote operation amount after the predetermined period elapses (in the case of the normal table 30B). In a case where the remote operation device 9 is operated with a predetermined remote operation amount, the relay operation amount transmitted to the work machine 2 before the predetermined period elapses is smaller than the relay operation amount transmitted to the work machine 2 after the predetermined period elapses.

In a case where it is determined that the time is before the predetermined period elapses, the operation command transmission unit 20A converts the second operation command based on the fine operation table 30A. In a case where it is determined that the time is before the predetermined period has elapsed, the operation command transmission unit 20A converts the second operation command based on the normal table 30B. As a result, when the remote operation device 9 is operated with the predetermined remote operation amount, the first operation speed of the work machine 2 before the predetermined period elapses is slower than the second operation speed of the work machine 2 after the predetermined period elapses.

In addition, a dead zone is provided for the remote operation amount. The dead zone is set to a predetermined range of the remote operation amount including a state where the remote operation amount is zero. When the remote operation amount is within the dead zone, the remote operation amount is treated as zero.

The operation speed of the work machine 2 is the operation speed of the operable unit of the work machine 2. Examples of the operable unit of the work machine 2 include the swing body 13, the working equipment 15, and the traveling body 14. The second operation command output from the remote operation device 9 includes a swing command for operating the swing body 13, a work command for operating the working equipment 15, and a travel command for operating the traveling body 14. The travel command includes a forward command to move the traveling body 14 forward and a backward command to move the traveling body 14 backward.

### <Remote Operation Method>

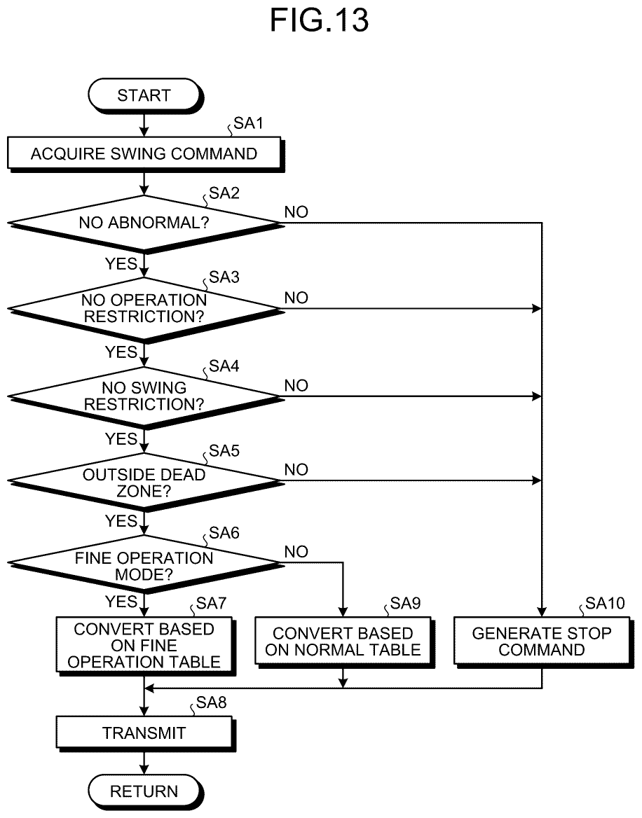

FIG. 13 is a flowchart illustrating a method of remotely operating the swing body 13 according to the present embodiment.

The determination unit 20C determines whether communication between the work machine 2 and the remote operation device 9 has been established. When the remote operation device 9 is operated after the communication is established, a swing command is output as a second operation command from the remote operation device 9. The operation command transmission unit 20A acquires the swing command (step SA1).

The determination unit 20C determines whether the communication is not abnormal (step SA2).

In a case where it is determined in step SA2 that the communication is not abnormal (step SA2: Yes), the determination unit 20C determines whether there is no operation restriction (step SA3).

In the present embodiment, the remote operation device 9 is provided with an operation restriction operation unit (not illustrated) that restricts the operation of the work machine 2. When the operation restriction operation unit is operated, the operation of the work machine 2 is restricted. When the operation of the work machine 2 is restricted, the neutral signal is output even when the remote operation device 9 is operated. As a result, the operation of the work machine 2 is restricted. The restriction of the operation of the work machine 2 includes restriction of the operation of the working equipment 15, restriction of the operation of the swing body 13, and restriction of the operation of the traveling body 14. The determination unit 20C determines whether the operation restriction operation unit is not operated.

In a case where it is determined in step SA3 that there is no operation restriction (step SA3: Yes), the determination unit 20C determines whether there is no swinging restriction (step SA4).

In the present embodiment, the remote operation device 9 is provided with a swing restriction operation unit (not illustrated) that restricts swing of the swing body 13. When the swing restriction operation unit is operated, swing of the swing body 13 is restricted. When the swinging of the swing body 13 is restricted, the neutral signal is output even when the remote operation device 9 is operated. As a result, the swinging of the swing body 13 is restricted. The determination unit 20C determines whether the swing restriction operation unit is not operated.

In a case where it is determined in step SA4 that there is no swing restriction (step SA4: Yes), the determination unit 20C determines whether the remote operation amount related to the swing command is outside the dead zone (step SA5).

In a case where it is determined in step SA5 that the remote operation amount is outside the dead zone (step SA5: Yes), the determination unit 20C determines whether the predetermined period has elapsed. That is, the determination unit 20C determines whether to set the fine operation mode for slowing the operation speed of the swing body 13 (step SA6).

In a case where it is determined in step SA6 that the predetermined period has not elapsed, that is, in a case where it is determined to set the fine operation mode (step SA6: Yes), the operation command transmission unit 20A converts the second operation command based on the fine operation table 30A. That is, the operation command transmission unit 20A converts the second operation command with a small gain (step SA7).

The operation command transmission unit 20A transmits the converted second operation command to the operation command transmitter 5 (step SA8).

In a case where it is determined in step SA6 that the predetermined period has elapsed, that is, in a case where it is determined to set the operation speed of the swing body 13 to the normal mode faster than the fine operation mode (step SA6: No), the operation command transmission unit 20A converts the second operation command based on the normal table 30B. That is, the operation command transmission unit 20A converts the second operation command with a large gain (step SA9).

The operation command transmission unit 20A transmits the converted second operation command to the operation command transmitter 5 (step SA8).

In a case where it is determined in step SA2 that there is an abnormality (step SA2: No), in a case where it is determined in step SA3 that there is an operation restriction (step SA3: No), in a case where it is determined in step SA4 that there is a swing restriction (step SA4: No), and in a case where it is determined in step SA5 that the remote operation amount is within a dead zone (step SA5: No), the operation command transmission unit 20A generates a stop command not to swing the swing body 13 (step SA10).

The operation command transmission unit 20A transmits the stop command to the operation command transmitter 5 (step SA8).

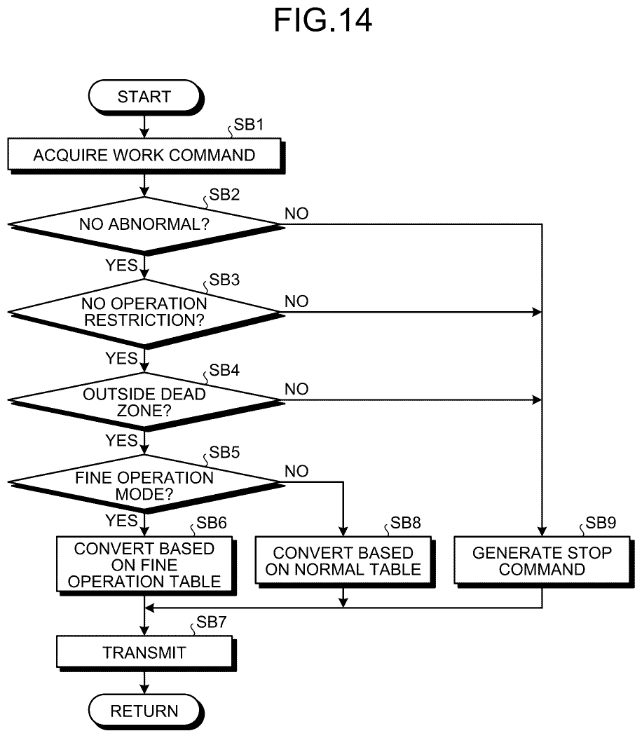

FIG. 14 is a flowchart illustrating a method of remotely operating the working equipment 15 according to the present embodiment.

The determination unit 20C determines whether communication between the work machine 2 and the remote operation device 9 has been established. When the remote operation device 9 is operated after the communication is established, a work command is output as a second operation command from the remote operation device 9. The operation command transmission unit 20A acquires the work command (step SB1).

The determination unit 20C determines whether the communication is not abnormal (step SB2).

In a case where it is determined in step SB2 that the communication is not abnormal (step SB2: Yes), the determination unit 20C determines whether there is no operation restriction (step SB3).

In a case where it is determined in step SB3 that there is no operation restriction (step SB3: Yes), the determination unit 20C determines whether the remote operation amount related to the work command is outside the dead zone (step SB4).

In step SB4, in a case where it is determined that the remote operation amount is outside the dead zone (step SB4: Yes), the determination unit 20C determines whether the time is before the predetermined period has elapsed. That is, the determination unit 20C determines whether to set the fine operation mode for reducing the operation speed of the working equipment 15 (step SB5).

In step SB5, in a case where it is determined that the predetermined period has not elapsed, that is, in a case where it is determined to set the fine operation mode (step SB5: Yes), the operation command transmission unit 20A converts the second operation command based on the fine operation table 30A. That is, the operation command transmission unit 20A converts the second operation command with a small gain (step SB6).

The operation command transmission unit 20A transmits the converted second operation command to the operation command transmitter 5 (step SB7).

In step SB5, in a case where it is determined that the predetermined period has elapsed, that is, in a case where it is determined to set the operation speed of the working equipment 15 to the normal mode faster than the fine operation mode (step SB5: No), the operation command transmission unit 20A converts the second operation command based on the normal table 30B. That is, the operation command transmission unit 20A converts the second operation command with a large gain (step SB8).

The operation command transmission unit 20A transmits the converted second operation command to the operation command transmitter 5 (step SB7).

In a case where it is determined in step SB2 that there is an abnormality (step SB2: No), in a case where it is determined in step SB3 that there is an operation restriction (step SB3: No), and in a case where it is determined in step SB4 that the remote operation amount is within a dead zone (step SB4: No), the operation command transmission unit 20A generates a stop command not to operate the working equipment 15 (step SB9).

The operation command transmission unit 20A transmits the stop command to the operation command transmitter 5 (step SB9).

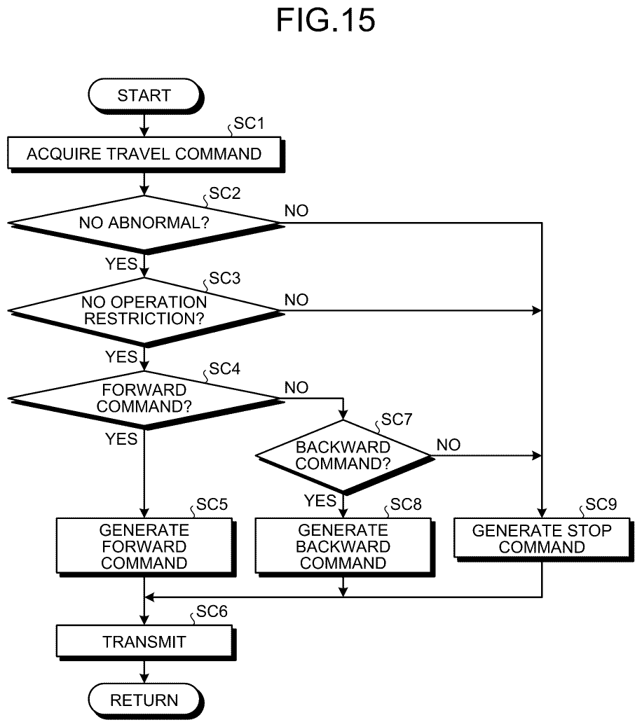

FIG. 15 is a flowchart illustrating a method of remotely operating the traveling body 14 according to the present embodiment.

The determination unit 20C determines whether the time is when the system in which communication between the work machine 2 and the remote operation device 9 is established is activated. After the system is started, when the remote operation device 9 is operated, a travel command is output as a second operation command from the remote operation device 9. The operation command transmission unit 20A acquires the travel command (step SC1).

The determination unit 20C determines whether the communication is not abnormal (step SC2).

In a case where it is determined in step SC2 that the communication is not abnormal (step SC2: Yes), the determination unit 20C determines whether there is no operation restriction (step SC3).

In a case where it is determined in step SC3 that there is no operation restriction (step SC3: Yes), the operation command transmission unit 20A determines whether the travel command is a forward command (step SC4).

In a case where it is determined in step SC4 that the travel command is the forward command (step SC4: Yes), the operation command transmission unit 20A generates the forward command as the second operation command (step SC5).

The operation command transmission unit 20A transmits the forward command to the operation command transmitter 5 (step SC6).

In a case where it is determined in step SC4 that the travel command is not a forward command (step SC4: No), the operation command transmission unit 20A determines whether the travel command is a backward command (step SC7).

In a case where it is determined in step SC7 that the travel command is the backward command (step SC7: Yes), the operation command transmission unit 20A generates the backward command as the second operation command (step SC8).

The operation command transmission unit 20A transmits the backward command to the operation command transmitter 5 (step SC6).

In a case where it is determined in step SC2 that there is an abnormality (step SC2: No), in a case where it is determined in step SC3 that there is an operation restriction (step SC3: No), and in a case where it is determined in step SC7 that the travel command is not a backward command (step SC7: No), the operation command transmission unit 20A generates a stop command not to cause the traveling body 14 to travel (step SB9).

The operation command transmission unit 20A transmits the stop command to the operation command transmitter 5 (step SC6).

### <Effects>

As described above, in the present embodiment, in a case where the remote operation device 9 is operated by the operator 10 when communication between the work machine 2 and the remote operation device 9 is established, the operation speed of the work machine 2 is controlled to be slower than the normal operation speed. That is, in a case where the operation mode of the work machine 2 includes the fine operation mode and the normal mode, the operation mode of the work machine 2 is forcibly set to the fine operation mode at a time point at which communication between the work machine 2 and the remote operation device 9 is established (system activation time point). For example, in a case where the operator 10 is not accustomed to the remote operation, the operator may hastily operate the remote operation device 9. In a case where the remote operation device 9 is hastily operated, the work machine 2 may hastily operate at the work site 3. In the present embodiment, since the operation speed of the work machine 2 is forcibly restricted at the time of system activation, even when the remote operation device 9 is hastily operated, the haste operation of the work machine 2 at the work site 3 is suppressed.

In the present embodiment, for example, a timer is provided in the remote controller 20, and the operation mode of the work machine 2 is changed from the fine operation mode to the normal mode in a case where the determination unit 20C determines that the predetermined period has elapsed from the time point when the communication between the work machine 2 and the remote operation device 9 is established based on the timer. The operation control unit 19A switches the operation speed of the work machine 2 from the first operation speed to the second operation speed after a lapse of a predetermined period from a time point at which the communication is established. This suppresses a decrease in work efficiency of the work machine 2.

### <Modifications>

In the present embodiment, the operation mode of the work machine 2 is set to the fine operation mode before the predetermined period elapses from the time point at which the communication between the work machine 2 and the remote operation device 9 is established based on the timer, and the operation mode of the work machine 2 is changed from the fine operation mode to the normal mode at the time point the predetermined period elapses from the time point at which the communication between the work machine 2 and the remote operation device 9 is established. That is, the operation control unit 19A switches the operation speed of the work machine 2 from the first operation speed to the second operation speed after a lapse of a predetermined period from a time point at which communication between the work machine 2 and the remote operation device 9 is established. The operation mode of the work machine 2 may be changed from the fine operation mode to the normal mode based on the release signal output from the remote operation device 9. That is, the operation control unit 19A may switch the operation speed of the work machine 2 from the first operation speed to the second operation speed based on the release signal output from the remote operation device 9. For example, after becoming accustomed to the remote operation, the operator 10 can change the operation mode of the work machine 2 from the fine operation mode to the normal mode by operating the remote operation device 9. This suppresses a decrease in work efficiency of the work machine 2. For example, when the remote operation device 9 is provided with a fine operation mode release operation unit, the operator 10 can change the operation mode of the work machine 2 from the fine operation mode to the normal mode by operating the fine operation mode release operation unit based on his/her own intention. When a fine operation mode release operation unit provided in the remote operation device 9 is operated, a release signal is generated in the remote operation device 9. The operation control unit 19A switches the operation speed of the work machine 2 from the first operation speed to the second operation speed based on the release signal output from the remote operation device 9. The operator 10 can set the operation mode of the work machine 2 to the normal mode by operating the fine operation mode release operation unit in the remote operation device 9.

Note that the operation control unit 19A may switch the operation speed of the work machine 2 from the first operation speed to the second operation speed based on the release signal output from the remote operation device 9 even before a predetermined period elapses from the time point at which the communication between the work machine 2 and the remote operation device 9 is established.

In the present embodiment, the work machine 2 is set to one of the fine operation mode and the normal mode based on the ratio (gain) between the relay operation amount and the remote operation amount. The work machine 2 may be set to one of the fine operation mode and the normal mode by changing the engine speed of the engine as the power source mounted on the work machine 2.

In the present embodiment, the conversion table described with reference to FIG. 12 is stored in the storage unit 20D of the remote controller 20. The conversion table may be stored in the relay controller 6 or may be stored in the in-vehicle controller 19.

In the present embodiment, as in the first embodiment and the second embodiment, the operation command transmitter 5 is operated based on the second operation command, and the operation control unit 19A controls the work machine 2 based on the first operation command from the operation command transmitter 5. In the present embodiment, the operation command transmitter 5 may be omitted. The operation control unit 19A may control the work machine 2 based on the second operation command from the operation command transmission unit 20A.

In the present embodiment, the operation command transmission unit 20A, the image reception unit 20B, the determination unit 20C, and the storage unit 20D may be configured by separate hardware (computer system).

### [Computer System]

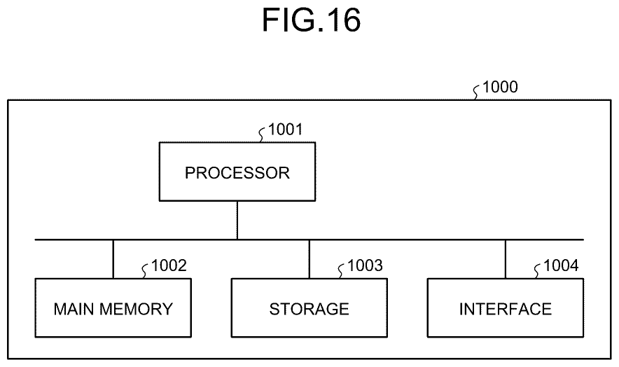

FIG. 16 is a block diagram illustrating a computer system 1000 according to an embodiment. Each of the remote controller 20, the relay controller 6, and the in-vehicle controller 19 described above includes a computer system 1000. The computer system 1000 includes a processor 1001 such as a central processing unit (CPU), a main memory 1002 including a nonvolatile memory such as a read only memory (ROM) and a volatile memory such as a random access memory (RAM), a storage 1003, and an interface 1004 including an input/output circuit. The function of each of the remote controller 20, the relay controller 6, and the in-vehicle controller 19 described above is stored in the storage 1003 as a computer program. The processor 1001 reads the computer program from the storage 1003, develops the computer program in the main memory 1002, and executes the above-described processing according to the program. Note that the computer program may be distributed to the computer system 1000 via a network.

According to the above-described embodiment, the computer program or the computer system 1000 can execute transmission of the first operation command for operating the work machine 2 from the operation command transmitter 5 to the work machine 2 via the first communication system 11, generation of the second operation command based on an operation signal generated by the remote operation device 9 for remotely operating the work machine 2, and output of the second operation command to the operation command transmitter 5 via the second communication system 12.

### Other Embodiments

In the embodiment described above, the work machine 1 is a loading excavator. The work machine 1 may be a backhoe. In the above-described embodiment, the work machine 1 includes the swing body 13 as the vehicle body, but the vehicle body of the work machine 1 may not be the swing body. The work machine 1 is only required to be a work machine having working equipment, and may be a bulldozer or a wheel loader. The work machine 1 may not have working equipment. The work machine 1 may be, for example, a haul vehicle having a dump body.

### REFERENCE SIGNS LIST

1 REMOTE OPERATION SYSTEM
2 WORK MACHINE
3 WORK SITE
4 REMOTE OPERATION ROOM
5 OPERATION COMMAND TRANSMITTER (FIRST OPERATION DEVICE)
6 RELAY CONTROLLER
6A OPERATION COMMAND RECEPTION UNIT
7 RELAY CHAMBER
8 INFORMATION TERMINAL
9 REMOTE OPERATION DEVICE (SECOND OPERATION DEVICE)
10 OPERATOR
11 FIRST COMMUNICATION SYSTEM
12 SECOND COMMUNICATION SYSTEM
13 SWING BODY
14 TRAVELING BODY
15 WORKING EQUIPMENT
15A BOOM
15B ARM
15C BUCKET
16 IMAGING DEVICE
16A FIRST CAMERA
16B SECOND CAMERA
17 IN-VEHICLE DISPLAY DEVICE
18 OPERATION COMMAND RECEIVER
19 IN-VEHICLE CONTROLLER
19A OPERATION CONTROL UNIT
19B IMAGE GENERATION UNIT
19C IMAGE TRANSMISSION UNIT
20 REMOTE CONTROLLER
20A OPERATION COMMAND TRANSMISSION UNIT
20B IMAGE RECEPTION UNIT
20C DETERMINATION UNIT
20D STORAGE UNIT
21 DISPLAY DEVICE
21A FIRST DISPLAY AREA
21B SECOND DISPLAY AREA
22 CONVERSION DEVICE
23 IMAGE TRANSMITTER
24 THIRD COMMUNICATION SYSTEM
25 IMAGE RECEIVER
26 BIRD'S EYE IMAGE
27 SINGLE CAMERA IMAGE
28 INDICATOR
28A FIRST FRAME
28B SECOND FRAME
28C SYMBOL
28D ORIGIN
29 REFERENCE LINE
29A REFERENCE LINE
29B REFERENCE LINE
29C REFERENCE LINE
30A FINE OPERATION TABLE (FIRST CONVERSION TABLE)
30B NORMAL TABLE (SECOND CONVERSION TABLE)
31 INCLINATION SENSOR
1000 COMPUTER SYSTEM
1001 PROCESSOR
1002 MAIN MEMORY
1003 STORAGE
1004 INTERFACE

1. A remote operation system of a work machine comprising:
a first operation device that transmits a first operation command to the work machine via a first communication system;
a second operation device that generates an operation signal for remotely operating the work machine; and
a remote controller that generates a second operation command based on the operation signal to output the second operation command to the first operation device via a second communication system.

2. The remote operation system of the work machine according to claim 1, wherein
the first operation device is disposed at a work site where the work machine operates, and
the second operation device is disposed at a location remote from the work site.

3. The remote operation system of the work machine according to claim 1, wherein
the first communication system transmits the first operation command to the work machine by a first communication method, and
the second communication system transmits the second operation command to the first operation device by a second communication method.

4. The remote operation system of the work machine according to claim 1, wherein
the first communication system transmits the first operation command by a radio wave.

5. The remote operation system of the work machine according to claim 1, wherein
the second communication system transmits the second operation command via an electric communication line.

6. The remote operation system of the work machine according to claim 1, wherein
the work machine operates based on the first operation command, and
the first operation device transmits the first operation command based on the second operation command.

7. The remote operation system of the work machine according to claim 6, further comprising:
a conversion device that converts the second operation command into the first operation command.

8. The remote operation system of the work machine according to claim 1, further comprising:
an in-vehicle controller that transmits an image of a work site where the work machine operates to a remote controller disposed at a location remote from the work site via the second communication system.

9. The remote operation system of the work machine according to claim 1, further comprising:
an image transmitter that transmits an image of a work site where the work machine operates via a third communication system.

10. The remote operation system of the work machine according to claim 9, wherein
the image transmitter transmits the image to an image receiver disposed at the work site, and
the remote operation system further comprises: a relay controller that transmits the image received by the image receiver via the second communication system to a remote controller disposed at a location remote from the work site.

11. A remote operation method for a work machine, the method comprising:
transmitting a first operation command for operating the work machine from a first operation device to the work machine via a first communication system;
generating a second operation command based on an operation signal generated by a second operation device that remotely operates the work machine; and
outputting the second operation command to the first operation device via a second communication system.
